(19) United States
(12) Patent Application Publication
(10) Pub. No.: US 2007/0171987 A1
(43) Pub. Date: Jul. 26, 2007

(54) Method for optical flow field estimation using adaptive Filting

(75) Inventor: Mejdi Trimeche, Tampere (FI)

Correspondence Address: Ware, Fressola, Van Der Sluys & Adolphson LLP, 755 Main Street, P.O. Box 224, Monroe, CT, 06468, US

(73) Assignee: Nokia Corporation

(21) Appl. No.: 11/336,617

(22) Filed: Jan. 20, 2006

(51) Int. Cl. H04B 1/66

(52) U.S. Cl. 375/240.27; 375/240.29

(57) ABSTRACT

A motion estimation process in video coding takes into account the estimates in the immediate spatio-temporal neighborhood, through an adaptive filtering mechanism, in order to produce a smooth and coherent optical flow field at each pixel position. The adaptive filtering mechanism includes a recursive LMS filter based on pixel-wise algorithm for obtaining motion vectors in a reference image of a video image frame, while consecutively scanning through individual pixels of the image frame. This motion estimation process is particularly well suited for the estimation of small displacements within consecutive video frames, and can be applied in several applications such as super-resolution, stabilization, denoising of video sequences. The method is also well suited for high frame rate video capture.

### FIELD OF THE INVENTION

The present invention relates generally to motion estimation and, more particularly, to optical flow estimation in the raw video domain.

### BACKGROUND OF THE INVENTION

Motion estimation and image registration tasks are fundamental to many image processing and computer vision applications. Model-based image motion estimation has been used in 3D image video capture to determine depth maps from 2D images. In computer vision, motion estimation has been used for image pixel registration. Motion estimation has also been used for object recognition and segmentation. Two major approaches have been developed for solving various problems in motion estimation: block matching or discrete motion estimation, and optical field estimation.

Motion estimation establishes the correspondences between the pixel positions from a target frame with respect to a reference frame. With block-matching, the discrete motion estimation establishes the correspondences by measuring similarities using blocks or masks. It is developed to improve the compression performance in video coding applications. For example, in many video coding standards, block-matching methods are used for motion estimation and compensation.

In general, the advantages of block-matching are simplicity and reliability for estimating discrete large motion. However, the drawbacks are that block-matching fails to catch detailed motion of a deformable-body and the result of block-matching does not necessarily reflect real motion. Because of its poor motion prediction along the moving boundaries, direct application of block-based motion estimation in filtering applications such as video image deblurring and noise reduction is relatively inefficient.

In optical field estimation, 2D motion in image sequences acquired by a video camera is considered as being induced by the movement of objects in a three-dimensional (3D) scene and the movement of the camera via a certain projection system. Upon this projection, 3D motion trajectories of object points in the scene become 2D motion trajectories (x(t), t) in camera coordinates. The 2D motion in the video images can be represented by a plurality of motion vectors in an optical flow field. When the 2D motion trajectories involve motion sampling at each pixel, the motion fields are called dense. Thus, a dense flow field is estimated as a pixel-wise process of interpolation from a motion trajectory field. Dense optical flow or dense motion estimation has found applications in computer vision for 3D structure recovery, in video processing for image deblurring, super-resolution and noise reduction.

Optical field estimation aims at obtaining a velocity field based on the computation of spatial and temporal image derivatives from the 2D motion trajectories. Using the partial derivatives computed over the intensity field of the derived gradient field, the optical flow methods handle the piecewise and detained variation of displacement. Known methods for estimation of dense optical field are typically computationally complex, and hence not suitable for real-time applications.

It is thus desirable and advantageous to provide a method for fast and smooth motion estimation that can be applied for several filtering applications.

### SUMMARY OF THE INVENTION

The present invention obtains motion vectors by recursively adapting a set of coefficients using a least mean square (LMS) filter, while consecutively scanning through individual pixels in any given scanning direction. The LMS filter, according to the present invention, is a pixel-wise algorithm that adapts itself recursively to match the pixels of an input image to those in a reference image. This matching is performed through the smooth modulation of the filter coefficient matrix as the scanning advances. The distribution of the adapted filter coefficients is used to determine the displacement of each pixel in the input image with respect to the reference image, at sub-pixel accuracy. According to the present invention, the motion estimation process takes into account the estimates in the immediate spatio-temporal neighborhood, through an adaptive filtering mechanism, in order to produce a smooth and coherent optical flow field at each pixel position. The method, according to the present invention, is particularly well suited for the estimation of small displacements within consecutive video frames, and can be applied in several applications such as super-resolution, stabilization, denoising of video sequences. The method is also well suited for high frame rate video capture.

The present invention will become apparent upon reading the description taken in conjunction with FIGS. 1 to 6.

### BRIEF DESCRIPTION OF THE DRAWINGS

FIG. 1 is a schematic representation of the filtering process for adapting the coefficients that are used to match the frames, according to the present invention.

FIG. 2 illustrates how motion is extracted from the adapted coefficient distribution.

FIG. 3 is a schematic representation of the scanning process, according to one embodiment of the present invention.

FIG. 4 is a schematic representation of the scanning process, according to another embodiment of the present invention.

FIG. 5 is a block diagram showing a video image transfer arrangement using a motion estimation, according to the present invention.

FIG. 6 illustrates an example of a video capture system utilizing the method of dense optical field estimation, according to the present invention.

### DETAILED DESCRIPTION OF THE INVENTION

The present invention involves registering a template image T in a target frame with respect to a reference image I in a reference frame. These two images are usually two successive frames of a video sequence. Both images are defined over the discrete grid positions k=[x,y]^{T},where 0≦x<X, 0≦y<Y. The image intensities are denoted by I(k) for the reference image and T(k) for the template image. The dense flow field is estimated based on the displacement between the target frame and the reference frame that happened in the corresponding time interval, and is defined as:
D(k)=[u(k),v(k)]^{T}. (1)

Here D(k) is the displacement vector which need not be an integer valued, and u(k) and v(k) are the corresponding horizontal and vertical components over the two-dimensional grid. With a constrained motion, D(k) is limited by

$$\{ \begin{matrix}- s \leq u ( k ) \leq s \\ - s \leq v ( k ) \leq s\end{matrix}$$

where 2*s+1 is the size of a search area or window that is centered at pixel location T(k) in the template image. The pixels inside this window are used to estimate the pixel value I(k) in the reference image.

In the registration process, according to the present invention, the matching error is minimized using a simple quadratic function such as
e(k)=(T(k)−Ĩ(k+D(k)))², (2)
where Ĩ denotes the estimated intensity value of image I at an integer or non-integer position defined by the displacement vector. In Equation 2, we used the quadratic error function for tractability of the formulation in case of Gaussian additive noise, but other error functions may be also used.

The formulation for pixel matching, according to the present invention, is based on the assumption that the pixel value I(k) in the reference image can be estimated using a linear combination of the pixel values in the window centered around T(k) in the template image. That is:
I(k)=w(k)^{T}*T_{w}(k)+η(k), (3)
where T_{w}(k) is a matrix of windowed pixel values from the template image, with size S=(2*s+1), and centered around the pixel position k. In Equation 3, w(k) corresponds to a coefficient matrix, and η(k) is an additive noise term. For notation convenience, the matrices T_{w}(k) and w(k) are ordered into column vectors, 0≦k≦XY.
Adaptive LMS Pixel Matching:

The model in Equation 3 indicates that each pixel value in the reference image can be estimated with a linear model of a window that contains the possible “delayed” or shifted pixels in the template image. Now the motion estimation problem can be mapped into the simpler problem of linear system identification. That is, it is possible to estimate w(k) based on the desired signal I(k) and the input data T_{w}(k).

To solve for w(k), we apply the standard LMS recursion:

$$\{ \begin{matrix}w ( k ) = w ( k - 1 ) + μ ( k ) {T}_{w} ( k ) e ( k ) , \\ e ( k ) = I ( k ) - {w ( k - 1 )}^{T} {T}_{w} ( k ) ,\end{matrix} \qquad ( 4 ) , ( 5 )$$

As such, the desired response to be matched is the pixel value in the reference image. In Equation 4, μ(k) is a positive step-size parameter; e(k) is the output estimation error; and w(k−1) refers to the coefficient values that were estimated on the previous pixel positions, following an employed scanning direction.

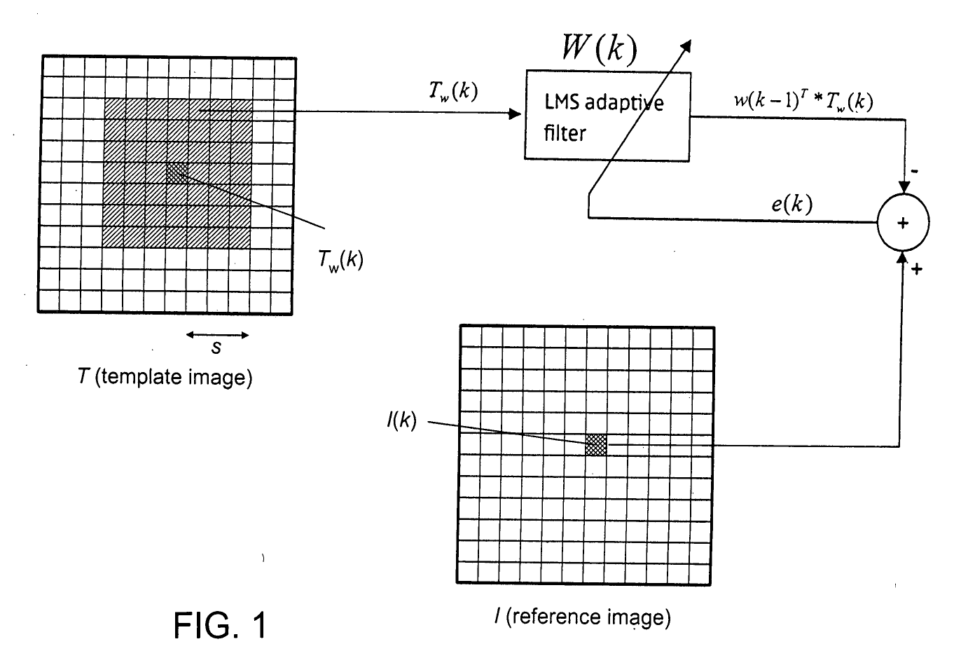

FIG. 1 illustrates the filtering process that is used for adapting the coefficients of the linear filter as a first step to obtain the motion at each pixel location.

For LMS adaptive filters, there is a well-studied trade-off between stability and speed of convergence. That is, a small enough step size μ(k) will result in slow convergence, whereas a large step size may result in unstable solutions. Additionally, there are several possible modifications of the LMS algorithm. According to the present invention, the normalized LMS (NLMS) is used for its simplicity and straightforward stability condition. The NLMS algorithm can be obtained by substituting in Equation 4 the following step-size:

$$μ ( k ) = \frac{μ}{ɛ + {‖ {T}_{w} ( k ) ‖}^{2}} \qquad ( 6 )$$

In this form, the filter is also called ε-NLMS. The stability condition is given by:

$$μ < \frac{2}{3} \qquad ( 7 )$$

The choice of the step-size parameter is essential in tuning the performance of the overall algorithm. In general, the motion can be assumed locally stationary. It is desirable to tune the algorithm by using a small step-size μ so as to favor a smooth and slowly varying motion field, rather than a spiky and fast changing motion field. It has been found that a small step size such as (μ=0.02) is appropriate.

Determining the Motion from the Adapted Filter Coefficients

The function of the adaptive filter that is described in the previous section is to match the pixels in a search window on the template image to the central pixel in the reference image. This matching is done through the smooth modulation of the filter coefficient matrix. In order to obtain the displacement vector D(k) from the adapted coefficient distribution w(k), a simple and fast filtering operation is used. In this filtering operation, the first step is to find the cluster of neighboring coefficients that contains the global maximum coefficient value. In the next step, the center of mass of the cluster is calculated over the support window. The result in x and y directions yields the horizontal and vertical components of D(k) at sub-pixel accuracy.

An exemplary implementation of this operation is as follows:
1. Find an n×n support window, over which the sum of neighboring coefficients is maximum, with n<s.
2. Check to see whether the sum is larger than a pre-determined threshold (confidence in the estimation process). If not, assert an empty pointer that is returned to indicate that no reliable motion can be estimated.
3. Calculate the center of mass over the obtained n×n support window. The vector from the origin to the resulting position is the estimated motion vector.
4. Another simple check based on the value of the error (as in Equation 5) can be used to confirm if a reliable motion estimate can be extracted from the coefficient distribution.

In the above filtering operation, n can be set to equal 3, for example.

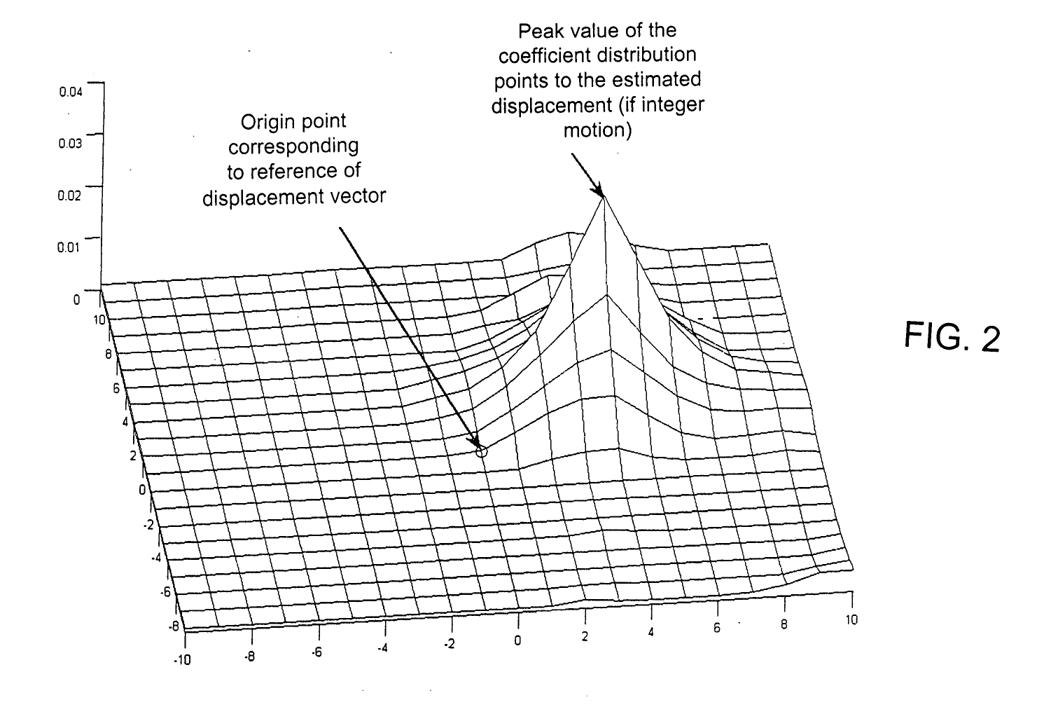

An example of the distribution of the adapted coefficient values is shown in FIG. 2 to illustrate how motion is extracted from the adapted coefficient distribution.

Scanning Direction

To describe the operation of the estimation method, according to the present invention, it should be appreciated that each image is composed of pixels. Each pixel may be represented as intensities of Red Green and Blue (RGB). In some image acquisition devices, the output RGB color data may be sampled according to the Bayer sampling pattern, with only one color intensity value per pixel position. We refer to this format as raw RGBG domain. Alternatively, each image may be represented as pixel intensities of the luminance (Y image) and two chrominance components (U, V images). This latter representation is frequently used in video coders and decoders.

The motion estimation method, according to the present invention, is based on an LMS adaptation by 1-D scanning of the 2D image pattern. The employed LMS adaptation is a causal process, which means that the coefficient values obtained at the previous pixel position, in accordance with the scanning direction, influence the output at the current pixel position. Hence, in practice, the choice of a particular scanning direction is important for correctly detecting the motion.

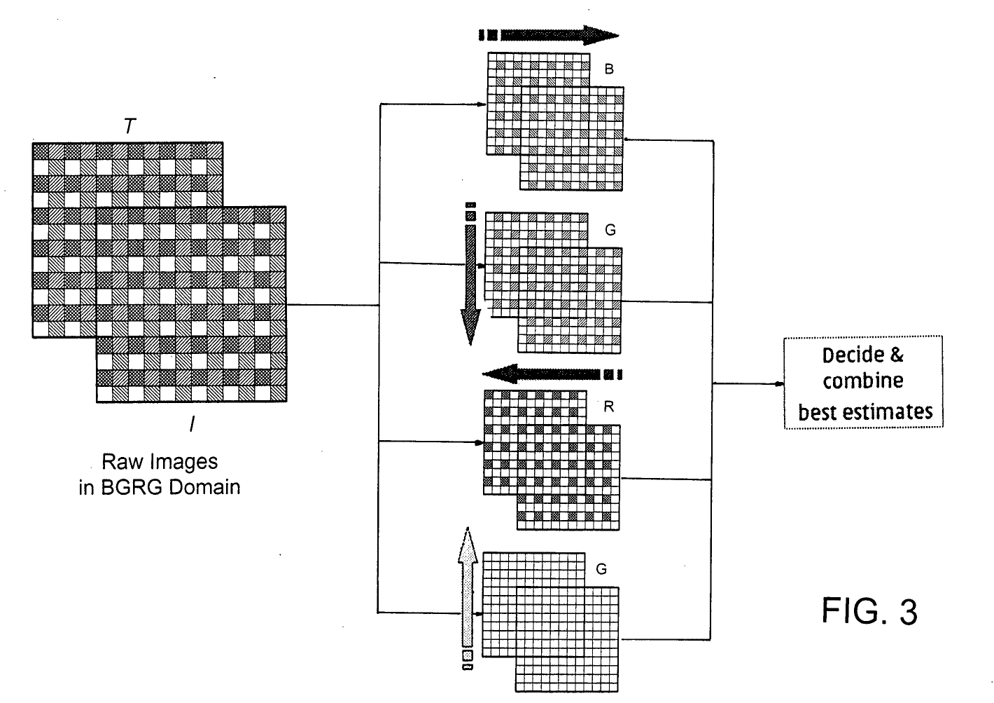

The flow field estimation using adaptive filter, according to the present invention, is used to perform motion estimation in the raw RGBG domain (Bayer image data). It is possible to perform the scanning in a number of directions. The Bayer image data in the raw RGBG domain inherently has four separate color components. It can be assumed that all of these color components undergo the same dense motion field. Thus, it is desirable to perform the scanning in four different directions, each direction separately for each color component (treated as a separate data source). This is done at no extra computational cost. The final motion field can be obtained by fusing the motion field obtained from the different directions. It is possible to select the motion vector that minimizes the corresponding error value at each pixel location as the criteria for the motion field fusion. To select such a motion vector, error images due to LMS adaptation can be stored temporarily in the memory. Another method for consolidating the motion vectors is to use a median selection. In the median selection method, the selection of the final motion field is based on a voting process, without the need for storage of the error components. FIG. 3 illustrates an algorithm for optical flow field motion estimation for use in raw RGBG domain, according to the present invention.

The above-described method can also be used for other image formats than raw RGBG data. For example, the same scanning and filtering method can be used for the luminance component of an image (Y image). In this case, the scanning and the consequent filtering may be performed from four different directions, either by revisiting each pixel four times from different scanning directions, or by decomposing the image into 4 different quadrants, and then performing the scanning on each quadrant from a different direction. The invented method can be applied either on full resolution image data or on sub-sampled parts of the image.

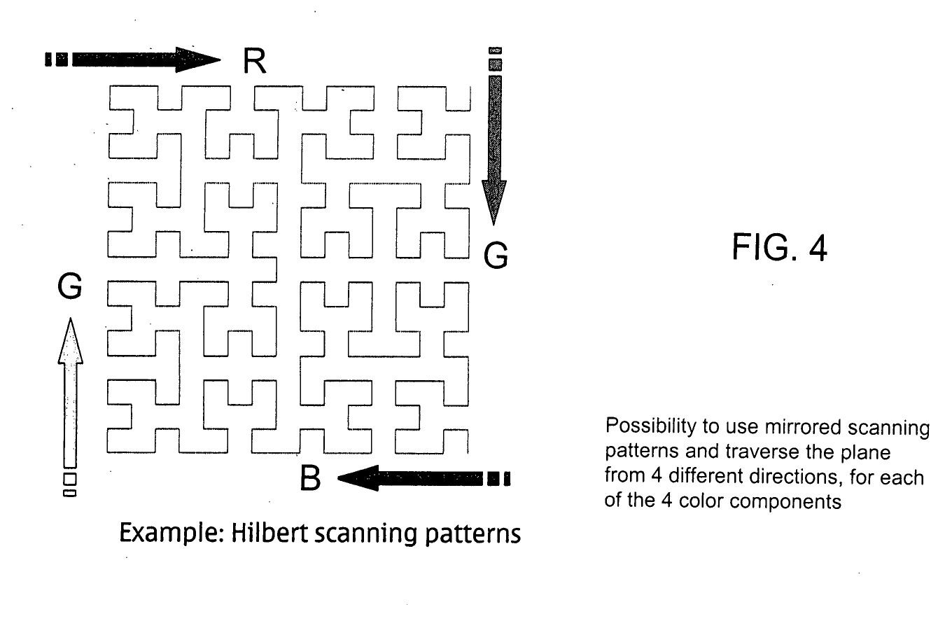

Furthermore, instead of the basic raster scan shown on FIG. 3, space-filling curves can be used to traverse the image plane in the coefficient adaptation process. One example of the space-filling patterns is the Hilbert scanning pattern, as shown in FIG. 4. This mode of scanning through the pixels is more complicated, but it has an advantage of staying localized within areas of similar frequencies before moving to another area. As such, it may result in a superior performance of the overall motion estimation process. The typical space filling patterns are defined over grid areas that are powers of 2. In FIG. 4, the scanning pattern is for a rectangular window of 16×16. It should be noted that the same pattern can be mirrored such that the image plane is traversed in four different directions. A similar fusion processing can be used to obtain a consolidated motion field.

Implementation

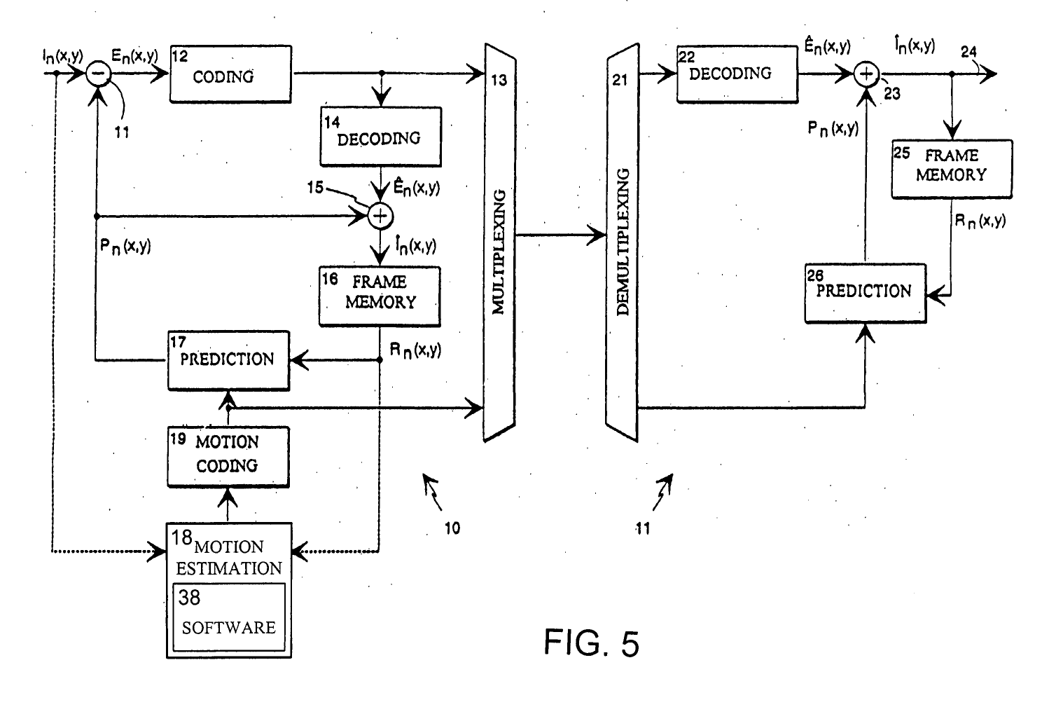

According to the present invention, the above-described algorithm is adapted in a video image transfer arrangement as shown in FIG. 5. The video image to be transferred is generally in a compressed form and formed of sequential images. In FIG. 5, block 18 corresponds to the motion field estimation system, according to the present invention.

As shown in FIG. 5, the current frame comes to the transmission system 10 as input data Iₙ(x,y). In the differential summing device 11, the input data is transformed into a differential frame Eₙ(x,y) by subtracting from it prediction frame Pₙ(x,y) formed on the basis of previous images. The differential frame is coded in block 12 and the coded differential frame is directed to a multiplexer 13. For forming a new prediction frame, the coded differential frame is also directed to the decoder 14, which produces a decoded differential frame Êₙ(x,y) which is summed in the summing device 15 with the prediction frame Pₙ(x,y), resulting in a decoded frame Îₙ(x,y). It is saved in the frame memory 16. For coding the next frame, the frame saved in the frame memory is read as a reference frame Rₙ(x,y) and in the motion compensation and prediction block 17 it is transformed into a new prediction frame. The displacements u(k) and v(k) in the two dimensional grid and the displacement vector D(k) are calculated in the motion estimation block 18 and the motion information coding block 19. The motion estimation block 18 has one or more sub-blocks for carrying out the scanning of the pixels in a video frame in a given scanning direction, for finding a match between the template image and the reference image, for computing the displacement distance, for determining the motion vector based on the displacement distance and the time interval between a target frame and a reference frame. Some or all of these steps can be carried out in a software module 38. Likewise, the LMS filter can part of the software module 38.

In the receiver 20, the demultiplexer 21 separates the coded differential frames and the motion information transmitted by the motion vectors and directs the coded differential frames to the decoder 22, which produces a decoded differential frame Êₙ(x,y) which is summed in the summing device 23 with the prediction frame Pₙ(x,y) formed on the basis of previous frames, resulting in a decoded frame Îₙ(x,y). It is directed to the output 24 of the reception decoder and at the same time saved in the frame memory 25. For decoding the next frame, the frame saved in the frame memory is read as a reference frame and transformed into a new prediction frame in the motion compensation and prediction block 26.

The video encoder system exploits the temporal redundancy by compensating for the estimated motion (in block 17), and encoding the error frames (block 12). The coarser and the finer the motion vectors are, the better the performance of the over-all system.

In sum, the motion estimation in a video sequence, according to the present invention, is carried out by:

scanning a target frame and a reference frame in the video frames in a predetermined pattern to cover part or all of the pixels in the reference frame;

for each of the pixels to be matched in the reference frame, defining a search area in the target frame;

filtering the pixels in the search area with a coefficient matrix having a plurality of coefficients, each coefficient corresponding to a pixel in the search area, for providing an estimated intensity value;

computing an error value between the estimated intensity value and the intensity value of said each pixel to be matched;

updating the coefficients in the coefficient matrix based on the error value for providing an updated coefficient matrix; and

determining a motion vector for said each pixel to be matched at least partially based on a subset of the updated coefficient matrix and the time interval.

The updated coefficient matrix comprises a plurality of updated coefficients, each updated coefficient having a coefficient value, and the updated coefficient matrix has a distribution of coefficient values over the search area. The determining step also includes the step of computing a displacement distance substantially based on the distribution of 30 coefficient values in the updated coefficient matrix so as to determine the motion vector for said each pixel to be matched based on the displacement distance.

Furthermore, a checking step is used to see whether we can confirm a match between the intensity value of said pixel to be matched when displaced according to determined motion vector and the intensity value of pixel in the search area so that the coefficient matrix is saved and used for the next pixel position, according to the predetermined scanning pattern.

The checking step can be carried out to see whether the greatest value among the coefficients in the updated coefficient matrix exceeds a predetermined value; the sum of coefficient values of the updated coefficients in the subset exceeds a predetermined value; or the error value exceeds the predetermined value.

Moreover, one or more different predetermined patterns can be used to the scanning for determining one or more further motion vectors for said each second pixel to be matched so that a refined motion vector can be computed based on said motion vector and said one or more further motion vectors.

The method for motion estimation, according to the present invention, is capable to produce precise sub-pixel motion vectors which help improve the trade-off between video quality and compression efficiency, without the need for explicit interpolation (as in traditional methods to obtain sub-pixel motion). Further, the invented method for fine motion estimation can be extended to define in a forward manner the motion vectors for the fine mode partitioning that are defined in the latest video coding standards. For example, H.264 coding standard supports partitioning within macroblocks. The newly defined INTER modes support up to 16×16 Motion Vectors (MV) in a single macroblock, each corresponding to motion that affects blocks as small as 4×4 pixels. The invented filtering scheme can be used to obtain fast decisions on the different INTER mode to be used at the encoder side, without the need for interpolation to obtain sub-pixel accuracy, separately for each of these different modes.

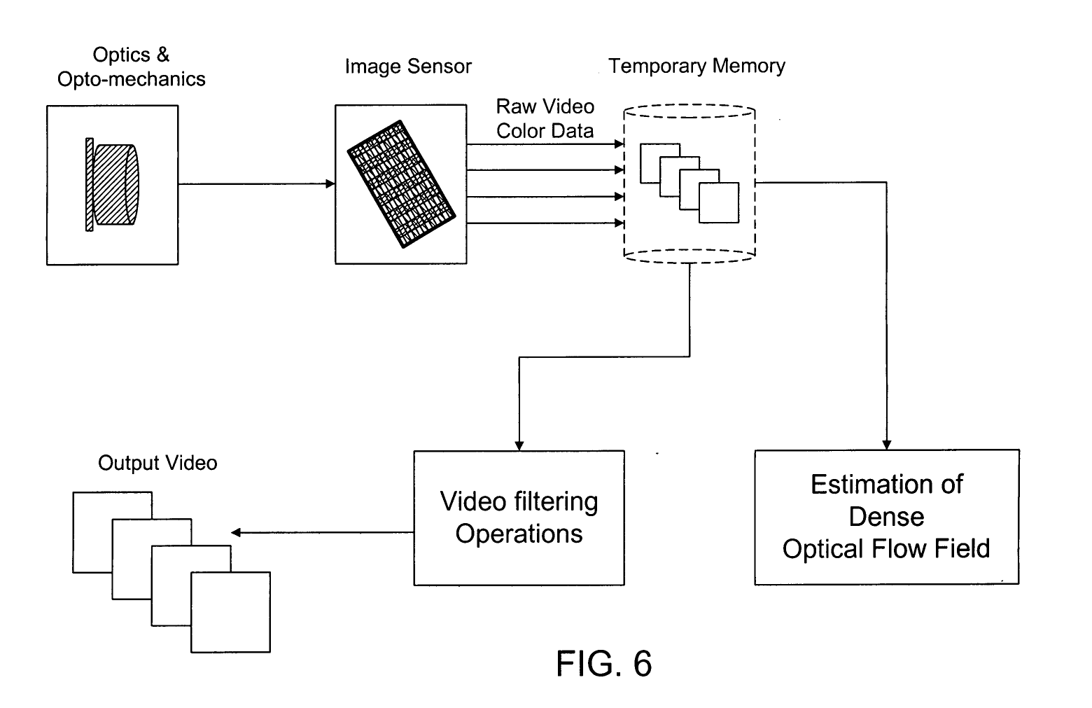

The present invention can be utilized in a method for forming a model for improving video quality captured with an imaging module comprising at least imaging optics and an image sensor, where the image is formed through the imaging optics, said image consisting of at least one color component. The method is integrated in a module that provides the correspondence between the pixels in the captured sequence of images (video), this module computes the motion that describes either the displacement of objects within the imaged scene, or the relative motion that happened with respect to the imaged scene. The module takes as input the data that was directly recorded by the sensor, as shown in FIG. 6, or alternatively further processed and stored sequence of images. The video filtering block utilizes the estimated displacement field at each pixel position (forming a dense field). The filtering can be optimized for example to reduce the noise level, or to improve visibility of small details, or to maintain the stability of the imaged scene.

Although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method of motion estimation in a video sequence having a plurality of video frames, the video frames including a first frame having a plurality of first pixels and a second frame having a plurality of second pixels, each second pixel having a corresponding first pixel, each of the second pixels having an intensity value, wherein the first frame and the second frame are separated by a time interval, said method comprising the steps of:
scanning the first frame and the second frame in a predetermined pattern to cover part or all of the second pixels;
for each second pixel to be matched in said part or all of the second pixels, defining a search area in the first frame;
filtering the first pixels in the search area with a coefficient matrix having a plurality of coefficients, each coefficient corresponding to one pixel in the search area, for providing an estimated intensity value;
computing an error value between the estimated intensity value and the intensity value of said each second pixel to be matched;
updating the coefficients in the coefficient matrix based on the error value for providing an updated coefficient matrix; and
determining a motion vector for said each second pixel to be matched at least partially based on at least part of the updated coefficient matrix and the time interval.

2. The method of claim 1, wherein the updated coefficient matrix comprises a plurality of updated coefficients, each updated coefficient having a coefficient value, and the updated coefficient matrix has a distribution of coefficient values over the search area, said determining step comprising the steps of:
computing a displacement distance substantially based on the distribution of coefficient values in the updated coefficient matrix so as to determine the motion vector for said each second pixel to be matched based on the displacement distance.

3. The method of claim 2, wherein the distribution has a greatest value among the coefficient values in the updated coefficient matrix, and the displacement distance is computed based on the greatest value.

4. The method of claim 3, further comprising the steps of:
checking to see whether the greatest value exceeds a predetermined value; and
using the updated coefficient matrix in said filtering step in determining the motion vector for a second pixel subsequent to said each second pixel in the predetermined scanning pattern, if said greatest value exceeds the predetermined value.

5. The method of claim 1, further comprising the steps of:
using one or more different predetermined patterns for said scanning step so as to determine one or more further motion vectors for said each second pixel to be matched; and
computing a refined motion vector based on said motion vector and said one or more further motion vectors.

6. The method of claim 1, wherein said updating step is based on a least mean squared recursion algorithm.

7. The method of claim 1, wherein said motion vector is determined based on a subset of the updated coefficient matrix and the time interval, and wherein said subset of the updated coefficient matrix comprises a plurality of updated coefficients, each updated coefficient having a coefficient value, said method further comprising the steps of:
checking to see whether a sum of the coefficient values of the updated coefficients in the subset exceeds a predetermined value; and
using the updated coefficient matrix in said filtering step in determining the motion vector for a second pixel subsequent to said each second pixel in the predetermined scanning pattern, if said sum exceeds the predetermined value.

8. The method of claim 1, further comprising the steps of:
checking to see whether the error value exceeds a predetermined value, and using the updated coefficient matrix in said filtering step in determining the motion vector for a second pixel subsequent to said each second pixel in the predetermined scanning pattern, if said error value exceeds the predetermined value.

9. The method of claim 1, wherein the search area is centered at the first pixel corresponding to said each second pixel.

10. A video encoder for coding a video sequence having a plurality of video frames, the video frames including a first frame having a plurality of first pixels and a second frame having a plurality of second pixels, each second pixel having a corresponding first pixel, each the second pixels having an intensity value, wherein the first frame and the second frame are separated by a time interval, said encoder comprising:
a frame memory for storing at least the first frame; and
a motion estimation module for receiving the second frame from the video sequence, the motion estimation module operatively connected to the frame memory for receiving the first frame, the motion estimation module comprising:
means for scanning the first frame and the second frame in a predetermined pattern to cover part or all of the second pixels, so as to define a search area in the first frame for each second pixel to be matched in said part or all of the second pixels;
an adaptive filter having a coefficient matrix for filtering the first pixels in the search area, the coefficient matrix having a plurality of coefficients, each coefficient corresponding to one pixel in the search area, for providing an estimated intensity value;
means for computing an error value between the estimated intensity value and the intensity value of said each second pixel to be matched, so as to update the coefficients in the coefficient matrix based on the error value for providing an updated coefficient matrix; and
means for determining a motion vector for said each second pixel to be matched at least partially based on at least part of the updated coefficient matrix and the time interval.

11. The video encoder of claim 10, wherein the updated coefficient matrix comprises a plurality of updated coefficients, each updated coefficient having a coefficient value, and the updated coefficient matrix has a distribution of coefficient values over the search area, and wherein said determining means also computes a displacement distance substantially based on the distribution of coefficient values in the updated coefficient matrix so as to determine the motion vector for said each second pixel to be matched based on the displacement distance.

12. The video encoder of claim 11, wherein the distribution has a greatest value among the coefficient values in the updated coefficient matrix, and the displacement distance is computed based on the greatest value.

13. The video encoder of claim 12, wherein the motion estimation module further comprises means for checking to see whether the greatest value exceeds a predetermined value so that the updated coefficient matrix is used in an adaptive filter in determining the motion vector for a second pixel subsequent to said each second pixel in the predetermined scanning pattern, if said greatest value exceeds the predetermined value.

14. A video image transfer system for use in coding a video sequence, the video sequence having a plurality of video frames, said video frames including a first frame having a plurality of first pixels and a second frame having a plurality of second pixels, each second pixel having a corresponding first pixel, each of the first pixels having a first intensity value and each of the second pixels having a second intensity value, wherein the first frame and the second frame are separated by a time interval, said transfer system comprising:
an encoder section, and
a decoder section, wherein
the encoder section comprises:
a frame memory for storing at least the first frame; and
a motion estimation module for receiving the second frame from the video sequence, the motion estimation module operatively connected to the frame memory for receiving the first frame, the motion estimation module comprising:
means for scanning the first frame and the second frame in a predetermined pattern to cover part or all of the second pixels, so as to define a search area in the first area for each second pixel to be matched in said part or all of the second pixels;
an adaptive filter having a coefficient matrix for filtering the first pixels in the search area, the coefficient matrix having a plurality of coefficients, each coefficient corresponding to one pixel in the search area, for providing an estimated intensity value;
means for computing an error value between the estimated intensity value and the intensity value of said each second pixel to be matched, so as to update the coefficients in the coefficient matrix based on the error value for providing an updated coefficient matrix; and
means for determining a motion vector for said each second pixel to be matched at least partially based on at least part of the updated coefficient matrix and the time interval, and wherein
the decoder section comprises:
a receiver for receiving from the encoder section the differential frame and information indicative of the motion vector;
a decoder module for providing a decoded differential frame; and
a summing device for reconstructing the second frame based on the decoded differential frame and the receive information indicative of the motion vector.

15. The video transfer system of claim 14, wherein the updated coefficient matrix comprises a plurality of updated coefficients, each updated coefficient having a coefficient value, and the updated coefficient matrix has a distribution of coefficient values over the search area, and wherein said determining means also computes a displacement distance substantially based on the distribution of coefficient values in the updated coefficient matrix so as to determine the motion vector for said each second pixel to be matched based on the displacement distance.

16. A software application product comprising a storage medium having a software application for use in motion estimation in a video sequence, the video sequence having a plurality of video frames, said video frames including a first frame having a plurality of first pixels and a second frame having a plurality of second pixels, each second pixel having a corresponding first pixel, each of the second pixels having a second intensity value, wherein the first frame and the second frame are separated by a time interval, said software application comprising program codes for carrying the method steps of claim 1.
